(19) United States
(12) Patent Application Publication
(10) Pub. No.: US 2026/0225542 A1
(43) Pub. Date: Aug. 6, 2026

(54) ELECTRIC WIRE FIXING MEMBER AND WIRE HARNESS

(71) Applicant: SUMITOMO WIRING SYSTEMS, LTD., Yokkaichi-shi, Mie (JP)

(72) Inventor: Naoto TSUKIMORI, Yokkaichi-shi, Mie (JP)

(73) Assignee: SUMITOMO WIRING SYSTEMS, LTD., Yokkaichi-shi, Mie (JP)

(21) Appl. No.: 19/150,092

(22) PCT Filed: Jan. 15, 2024
(86) PCT No.: PCT/JP2024/000786

§ 371 Date: Jul. 22, 2025

(30) Foreign Application Priority Data
Feb. 3, 2023 (JP) 2023-015318

(51) Int. Cl. B60R 16/02; H02G 3/32

(52) U.S. Cl. CPC B60R 16/0215; H02G 3/32

(57) ABSTRACT

A wire fixing member configured to fix a wire to a fixed portion, the wire fixing member including: a fixing member body that is configured to hold the wire, the fixing member body including an insertion hole into which the fixed portion is to be inserted; and an insertion body that is separate from the fixing member body and configured to be inserted into the insertion hole together with the fixed portion in order to press the fixed portion against an inner surface of the insertion hole.

### BACKGROUND

The present disclosure relates to a wire fixing member and a wire harness.

JP 2012-110133A discloses a wire fixing member configured to be fixed to a plate-like bracket provided in a vehicle, for example. The wire fixing member includes a holding portion that holds a wire member and a fixing portion configured to be fixed to the plate-like bracket. The fixing portion has an insertion hole into which the bracket is inserted. A locking portion that engages with the bracket is provided inside the insertion hole so as to prevent the bracket from coming out of the insertion hole.

### SUMMARY

The thicknesses of brackets in a vehicle are set to various thicknesses depending on the weight and the like of the wire members, from the viewpoint of securing strength. With the wire fixing member described above, it is necessary to design the size of the insertion hole and the like in accordance with the thickness of the bracket. For example, consider the case where a wire fixing member suitable for a first bracket is fixed to a second bracket that is thinner than the first bracket. In this case, a large gap formed between the insertion hole of the wire fixing member and the second bracket may cause rattling or even dropout of the wire fixing member. Therefore, it is necessary to prepare various types of wire fixing members according to the thickness of the bracket.

An exemplary aspect of the disclosure provides a wire fixing member and a wire harness that enable an improvement in versatility.

A wire fixing member according to the present disclosure is a wire fixing member configured to fix a wire member to a plate-like fixed portion, the wire fixing member including: a fixing member body including a holding portion configured to hold the wire member, and an insertion hole into which the fixed portion is to be inserted; and an insertion member that is separate from the fixing member body and configured to be inserted into the insertion hole together with the fixed portion to press the fixed portion against an inner surface of the insertion hole.

With the wire fixing member and the wire harness according to the present disclosure, it is possible to improve the versatility.

### BRIEF DESCRIPTION OF THE DRAWINGS

FIG. 1 is an exploded perspective view of a wire harness according to an embodiment.

FIG. 2 is a plan view of the wire harness according to the embodiment.

FIG. 3 is a cross-sectional view taken along line 3-3 in FIG. 2.

FIG. 4 is a cross sectional view taken along line 4-4 in FIG. 2.

FIG. 5 is a plan view of a wire harness according to a variation.

### DETAILED DESCRIPTION OF EMBODIMENTS

### Description of Embodiments of Present Disclosure

First, embodiments of the present disclosure will be listed and described.

A wire fixing member according to the present disclosure is

[1] a wire fixing member configured to fix a wire member to a plate-like fixed portion, the wire fixing member including: a fixing member body including a holding portion configured to hold the wire member, and an insertion hole into which the fixed portion is to be inserted; and an insertion member that is separate from the fixing member body and configured to be inserted into the insertion hole together with the fixed portion to press the fixed portion against an inner surface of the insertion hole.

With this configuration, since the fixed portion is pressed against the inner surface of the insertion hole by the insertion member, rattling between the insertion hole and the fixed portion can be suppressed. By changing the size of the insertion member in accordance with the thickness of the fixed portion, it is possible to use one type of fixing member body to accommodate various types of fixed portions having different thicknesses. In other words, changes in the thickness of the fixed portion can be accommodated by merely changing the design of the insertion member. As a result, the versatility of the wire fixing member can be improved.

[2] In the configuration of [1] above, it is also possible that the fixing member body includes an elastic piece inside the insertion hole, the elastic piece includes a locking portion configured to engage with the fixed portion so as to prevent the fixed portion from coming out of the insertion hole, and the insertion member and the elastic piece are provided on opposite sides of the fixed portion in a thickness direction.

According to this configuration, it is possible to configure the wire fixing member such that the insertion member does not interfere with the elastic piece inside the insertion hole. Accordingly, it is possible to minimize the influence of the insertion member on the engagement of the locking portion of the elastic piece with the fixed portion.

[3] In the configuration of [1] or [2] above, it is also possible that the insertion member includes an insertion member body and a reinforcement rib protruding from the insertion member body.

With this configuration, the reinforcement rib can improve the rigidity of the insertion member. By ensuring rigidity with the reinforcement rib, the thickness of the insertion member body can be reduced.

[4] In the configuration of [3] above, it is also possible that the insertion member body includes a first side surface that comes into contact with the fixed portion and a second side surface that is on a back side of the first side surface, and the reinforcement rib is provided only on the second side surface and not the first side surface.

According to this configuration, since no reinforcement ribs are provided on the first side surface of the insertion member body, it is possible to obtain a large contact area between the first side surface and the fixed portion.

In the configuration of [3] or [4] above, a plurality of the reinforcement ribs may also be provided.

According to this configuration, the rigidity of the insertion member can be further improved by the plurality of reinforcement ribs.

[6] A wire harness according to the present disclosure includes the wire fixing member according to any one of [1] to [5], and a wire member held by the wire fixing member.

According to this configuration, it is possible to achieve operations and effects similar to those of the above wire fixing member.

### Details of Embodiments of the Present Disclosure

Specific examples of a wire fixing member and a wire harness according to the present disclosure will be described below with reference to the drawings. In the drawings, the configurations may be partially exaggerated or simplified for convenience in the description. Also, the dimensional ratios of various portions may differ among the drawings. The terms “parallel” and “orthogonal” in this specification include not only strictly parallel and orthogonal relationships, but also approximately parallel and orthogonal relationships to the extent that effects of the present embodiment are exhibited.

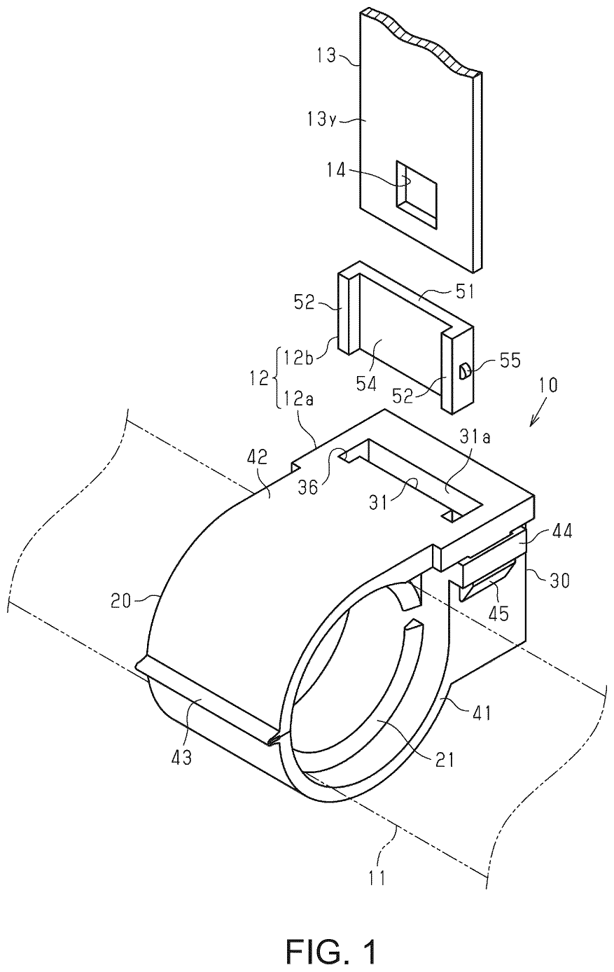

As shown in FIG. 1, a wire harness 10 according to this embodiment is provided in a vehicle such as an automobile, for example. The wire harness 10 includes a wire member 11 (wire) and a wire fixing member 12. The wire fixing member 12 is a component for fixing to a plate-like fixed portion 13 provided in the vehicle. The fixed portion 13 is, for example, a metal plate-like bracket. The wire member 11 electrically connects two or more in-vehicle devices to each other. The wire member 11 includes, for example, a wire and an exterior member that covers the wire.

### Wire Fixing Member 12

The wire fixing member 12 includes a fixing member body 12a, and an insertion member 12b (insertion body) that is separate from the fixing member body 12a. The fixing member body 12a and the insertion member 12b are made of synthetic resin, for example.

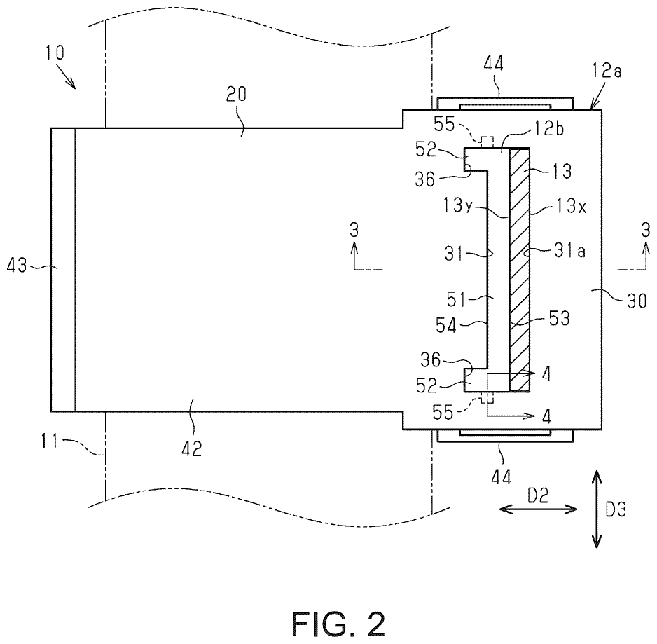

As shown in FIGS. 1 and 2, the fixing member body 12a has a holding portion 20 that holds the wire member 11 and a fixing portion 30 that is fixed to the fixed portion 13.

The holding portion 20 has an annular shape as viewed from the length direction of the wire member 11. The holding portion 20 surrounds the wire member 11. In this manner, the wire member 11 is held by the holding portion 20. The holding portion 20 includes, for example, a protruding portion 21 protruding from an inner circumferential surface of the holding portion 20. The protruding portion 21 is configured to restrict the wire member 11 from moving in the length direction. Relative positional shifting of the wire member 11 and the wire fixing member 12 in the length direction is suppressed by the protruding portion 21 restricting the wire member 11 from moving in the length direction. When the above-described exterior member of the wire member 11 is, for example, a corrugated tube, the protruding portion 21 fits into a recessed portion of the outer circumferential surface of the corrugated tube.

### Fixing Portion 30

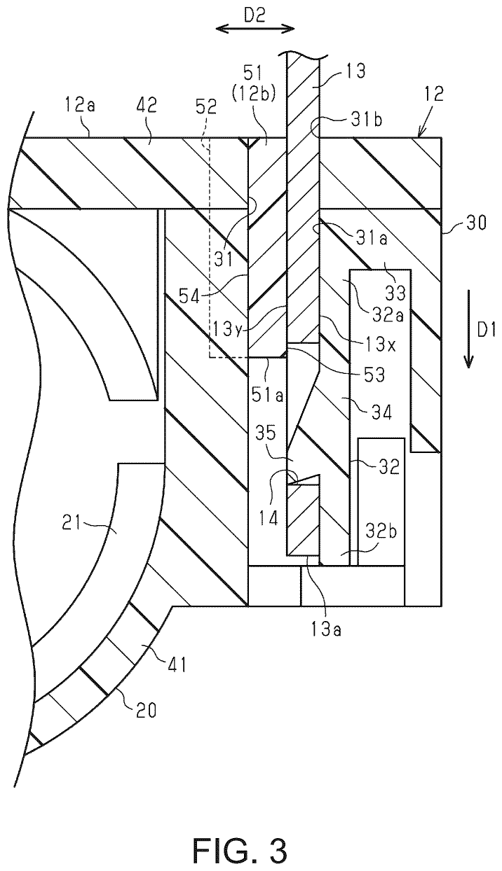

As shown in FIG. 3, the fixing portion 30 has an insertion hole 31 into which the fixed portion 13 is inserted along an insertion direction D1, and an elastic piece 32 located inside the insertion hole 31. The insertion hole 31 extends through a base portion 33 of the fixing portion 30 in the insertion direction D1. The elastic piece 32, for example, extends from the base portion 33 of the fixing portion 30 along the insertion direction D1. The elastic piece 32 is configured to bend with a base end portion 32a, which is connected to the base portion 33, serving as a fulcrum. In other words, the elastic piece 32 is configured to bend so that a distal end portion 32b thereof is displaced substantially along a direction orthogonal to the insertion direction D1.

The elastic piece 32 has a body portion 34 and a locking portion 35 (lock) protruding from the body portion 34. The body portion 34 extends from the base portion 33 along the insertion direction D1. The locking portion 35 protrudes from the body portion 34 in a direction intersecting the insertion direction D1.

The plate-like fixed portion 13 has a first main surface 13x and a second main surface 13y that are parallel to each other. The fixed portion 13 has, for example, a locking hole 14 configured to engage with the locking portion 35. The locking hole 14 is, for example, a through hole extending through the fixed portion 13 from the first main surface 13x to the second main surface 13y.

In the state where the fixed portion 13 is attached to the insertion hole 31, the body portion 34 of the elastic piece 32 is in contact with the first main surface 13x of the fixed portion 13. The locking portion 35 of the elastic piece 32 enters the locking hole 14 of the fixed portion 13. The edge portion of the locking hole 14 engages with the locking portion 35 inserted into the locking hole 14 in the direction opposite to the insertion direction D1. This engagement prevents the fixed portion 13 from coming out of the insertion hole 31.

The fixing member body 12a is, for example, divided into two parts, namely, a first part 41 and a second part 42, from the holding portion 20 to the fixing portion 30. The first and second parts 41 and 42 are connected to each other via a hinge portion 43. The first part 41, the second part 42, and the hinge portion 43 are formed as one piece. The second part 42 can be rotated about the hinge portion 43 relative to the first part 41. The hinge portion 43 is provided, for example, in the holding portion 20.

The second part 42 has hook portions 45 that are locked to lock portions 44 provided on the first part 41. The hook portions 45 are locked by the lock portions 44 to keep the first and second parts 41 and 42 closed.

The fixing portion 30 of the fixing member body 12a is constituted by a portion of the first part 41 and a portion of the second part 42. The base portion 33 and the elastic piece 32 of the fixing portion 30 are, for example, portions included in the first part 41. The insertion hole 31 extends over the first part 41 and the second part 42 in the fixing portion 30.

### Insertion Member 12b

As shown in FIGS. 1 and 2, the insertion member 12b is a component that is inserted into the insertion hole 31 together with the fixed portion 13. The insertion member 12b is inserted into the insertion hole 31 along the insertion direction D1.

As shown in FIG. 3, inside the insertion hole 31, the insertion member 12b is disposed in contact with the second main surface 13y of the fixed portion 13. In other words, the insertion member 12b is disposed on the opposite side to the elastic piece 32 that is in contact with the first main surface 13x of the fixed portion 13, with respect to the fixed portion 13. In other words, the insertion member 12b and the elastic piece 32 are provided on opposite sides of the fixed portion 13 in the thickness direction.

As shown in FIGS. 2 and 3, the insertion member 12b has an insertion member body 51 and reinforcement ribs 52 protruding from the insertion member body 51. The insertion member body 51 substantially has a prism shape, for example. The insertion member body 51 has a thickness direction D2 orthogonal to the insertion direction D1. The insertion member body 51 has a width direction D3 that is orthogonal to the insertion direction D1 and the thickness direction D2 (see FIG. 2).

The insertion member body 51 has a first side surface 53 that comes into contact with the second main surface 13y of the fixed portion 13 and a second side surface 54 on the back side of the first side surface 53. The first side surface 53 and the second side surface 54 are, for example, planar and parallel to each other. The first side surface 53 and the second side surface 54 are perpendicular to the thickness direction D2, for example.

### Reinforcement Ribs 52

As shown in FIG. 2, a plurality of reinforcement ribs 52 are provided, for example. The reinforcement ribs 52 protrude from the second side surface 54 of the insertion member body 51 along the thickness direction D2. The reinforcement ribs 52 are provided only on the second side surface 54 and not the first side surface 53. The reinforcement ribs 52 are provided, for example, at opposite ends of the insertion member body 51 in the width direction D3. The reinforcement ribs 52 extend in a straight line in a direction along the insertion direction D1, for example. The reinforcement ribs 52 extend, for example, from one end of the insertion member body 51 to the other end in the direction along the insertion direction D1.

The insertion hole 31 has recessed portions 36 recessed in the thickness direction D2. The number of recessed portions 36 is the same as the number of reinforcement ribs 52 of the insertion member 12b. That is, in the present embodiment, the number of recessed portions 36 is two. The recessed portions 36 extend in a straight line along the insertion direction D1, for example. The recessed portions 36 are respectively provided, for example, at opposite ends of the insertion hole 31 in the width direction D3. The reinforcement ribs 52 of the insertion member 12b respectively enter the recessed portions 36.

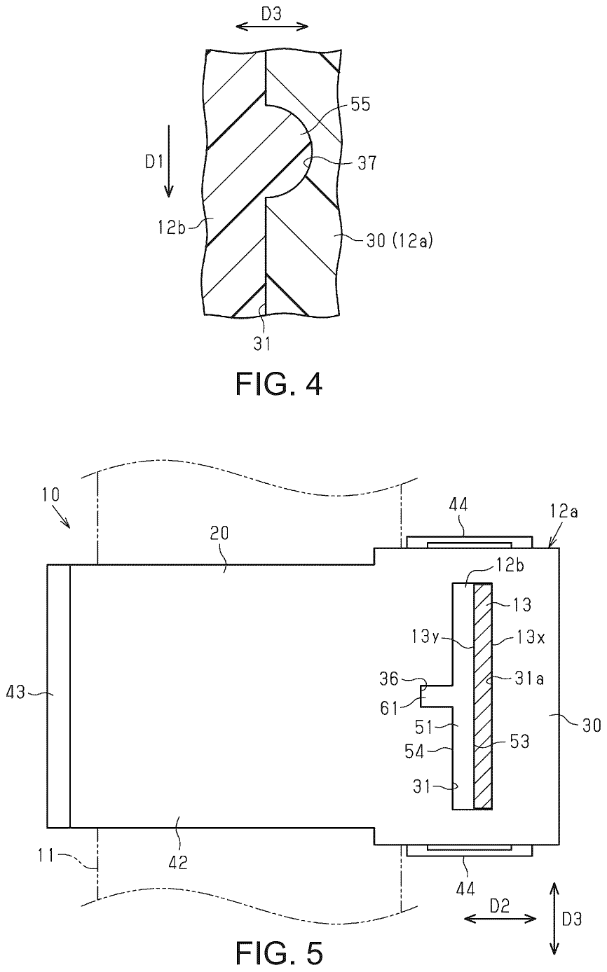

As shown in FIG. 4, fitting protruding portions 55 are respectively provided on two side surfaces of the insertion member 12b in the width direction D3. Fitting recessed portions 37 into which the fitting protruding portions 55 fit are provided on side surfaces of the insertion hole 31 in the width direction D3. When the fitting protruding portions 55 are fitted into the fitting recessed portions 37, the insertion member 12b is unlikely to come out of the insertion hole 31. Also, when the fitting protruding portions 55 are fitted into the fitting recessed portions 37, the insertion member 12b is positioned in the insertion direction D1. The fitting protruding portions 55 are provided, for example, on opposite sides of the insertion member 12b in the width direction D3. The fitting recessed portions 37 are provided, for example, on opposite sides of the insertion hole 31 in the width direction D3. The fitting protruding portions 55 respectively fit into the fitting recessed portions 37.

FIG. 3 shows the insertion member 12b in the proper attachment position in the direction along the insertion direction D1. The “proper attachment position of the insertion member 12b” mentioned above is the position where the insertion member 12b is positioned in the direction along the insertion direction D1 due to the fitting protruding portions 55 being fitted into the fitting recessed portions 37. As shown in FIG. 3, in the direction along the insertion direction D1, the distance from an entrance end 31b of the insertion hole 31 to a lower end 51a of the insertion member body 51 is shorter than the distance from the entrance end 31b of the insertion hole 31 to the locking portion 35. Therefore, the insertion member body 51 of the insertion member 12b is configured so as not to face the locking portion 35 in the thickness direction of the fixed portion 13. In this manner, interference of the insertion member body 51 with the locking portion 35 is suppressed.

The length of the insertion member body 51 in the direction along the insertion direction D1 is set to, for example, at least half the length of the portion of the fixed portion 13 inserted into the insertion hole 31. The length of the portion of the fixed portion 13 inserted into the insertion hole 31 is the length from the entrance end 31b of the insertion hole 31 to the distal end 13a of the fixed portion 13 in the insertion direction D1. In this manner, the fixed portion 13 can be stably held by the insertion member body 51.

### Operations of Present Embodiment

The insertion member 12b is, for example, press-fitted into the insertion hole 31 into which the fixed portion 13 has been previously inserted. As a result, the first side surface 53 of the insertion member body 51 comes into contact with the second main surface 13y of the fixed portion 13 inside the insertion hole 31. The fixed portion 13 is then subjected to stress from the insertion member 12b, and at least part of the first main surface 13x of the fixed portion 13 is pressed against an inner surface 31a of the insertion hole 31. In this manner, rattling between the fixed portion 13 and the insertion hole 31 is suppressed.

In the wire fixing member 12 of the present embodiment, by changing the dimension in the thickness direction D2 of the insertion member body 51 in accordance with the thickness of the fixed portion 13, it is possible to use one type of fixing member body 12a to accommodate various types of fixed portions 13 having different thicknesses. Therefore, by merely changing the design of the insertion member 12b, it is possible to address a change in the thickness of the fixed portion 13.

### Effects of Embodiment

(1) The insertion member 12b, which is separate from the fixing member body 12a, is inserted into the insertion hole 31 together with the fixed portion 13 and presses the fixed portion 13 against the inner surface 31a of the insertion hole 31. According to this configuration, since the fixed portion 13 is pressed against the inner surface 31a of the insertion hole 31 by the insertion member 12b, rattling between the insertion hole 31 and the fixed portion 13 can be suppressed. By changing the size of the insertion member 12b in accordance with the thickness of the fixed portion 13, it is possible to use one type of fixing member body 12a to accommodate various types of fixed portions 13 having different thicknesses. In other words, changes in the thickness of the fixed portion 13 can be addressed by merely changing the design of the insertion member 12b. As a result, the versatility of the wire fixing member 12 can be improved.

(2) The fixing member body 12a has the elastic piece 32 inside the insertion hole 31. The elastic piece 32 has the locking portion 35 that engages with the fixed portion 13 to prevent the fixed portion 13 from coming out of the insertion hole 31. The insertion member 12b and the elastic piece 32 are provided on opposite sides of the fixed portion 13 in the thickness direction. According to this configuration, it is possible to configure the insertion member 12b not to interfere with the elastic piece 32 inside the insertion hole 31. Therefore, it is possible to suppress the influence of the insertion member 12b on the engagement of the locking portion 35 of the elastic piece 32 with the fixed portion 13.

(3) The insertion member 12b has the insertion member body 51 and the reinforcement rib 52 protruding from the insertion member body 51. According to this configuration, the rigidity of the insertion member 12b can be improved by the reinforcement rib 52. The rigidity is ensured by the reinforcement rib 52, making it possible to reduce the thickness of the insertion member body 51.

(4) The insertion member body 51 has the first side surface 53 that comes into contact with the fixed portion 13 and the second side surface 54 on the back side of the first side surface 53. The reinforcement rib 52 is provided only on the second side surface 54 and not the first side surface 53. According to this configuration, since no reinforcement rib 52 is provided on the first side surface 53 of the insertion member body 51, it is possible to obtain a larger contact area between the first side surface 53 and the fixed portion 13.

(5) A plurality of the reinforcement ribs 52 are provided. According to this configuration, the rigidity of the insertion member 12b can be further improved by the plurality of reinforcement ribs 52.

(6) The insertion member 12b is configured not to face the locking portion 35 in the thickness direction of the fixed portion 13. This prevents the insertion member body 51 from interfering with the locking portion 35. As a result, the influence of the insertion member 12b on the engagement of the locking portion 35 with the fixed portion 13 can be further reduced.

### Variations

The present embodiment can be implemented with variations such as the following. The present embodiment and the following variations can be implemented in combination with each other as long as no technical contradiction arises.

In the insertion member 12b, there may be only one or three or more reinforcement ribs 52. Each reinforcement rib 52 may be provided at a position other than opposite ends of the insertion member body 51 in the width direction D3.

The configuration of the reinforcement ribs 52 of the insertion member 12b can be modified, for example, as shown in FIG. 5. In the example shown in FIG. 5, the insertion member 12b has one reinforcement rib 61 protruding from the insertion member body 51. The reinforcement rib 61 protrudes from the second side surface 54 of the insertion member body 51 along the thickness direction D2. The reinforcement rib 61 is provided only on the second side surface 54 and not the first side surface 53. The reinforcement rib 61 is provided, for example, in the center portion of the insertion member body 51 in the width direction D3. The reinforcement rib 61 extends, for example, in a straight line in the direction along the insertion direction D1. The reinforcement rib 61 extends, for example, from one end of the insertion member body 51 to the other end in the direction along the insertion direction D1. In the insertion hole 31, only one recessed portion 36, into which the reinforcement rib 61 enters, is provided at a position corresponding to the reinforcement rib 61. In other words, in the example shown in FIG. 5, the recessed portion 36 is provided in the center portion of the insertion hole 31 in the width direction D3. This configuration also makes it possible to improve the rigidity of the insertion member 12b by the reinforcement rib 61. The rigidity is secured by the reinforcement rib 61, making it possible to reduce the thickness of the insertion member body 51.

In the direction along the insertion direction D1, the distance from the entrance end 31b of the insertion hole 31 to the lower end 51a of the insertion member body 51 may be equal to the distance from the entrance end 31b of the insertion hole 31 to the locking portion 35. Alternatively, in the direction along the insertion direction D1, the distance from the entrance end 31b of the insertion hole 31 to the lower end 51a of the insertion member body 51 may be longer than the distance from the entrance end 31b of the insertion hole 31 to the locking portion 35. In other words, the insertion member body 51 of the insertion member 12b may be configured to face the locking portion 35 in the thickness direction of the fixed portion 13.

In the insertion member 12b, the reinforcement ribs 52 may be provided only on the first side surface 53 of the insertion member body 51. The reinforcement ribs 52 may be provided on both the first side surface 53 and the second side surface 54 of the insertion member body 51.

In the insertion member 12b of the above embodiment, the reinforcement ribs 52 may be omitted.

The locking hole 14 in the fixed portion 13 may be a recessed portion formed in the first main surface 13x. In other words, the locking hole 14 may be configured not to extend through from the first main surface 13x to the second main surface 13y of the fixed portion 13.

The locking portion 35 of the elastic piece 32 may be a recessed portion or a hole that engages with a protruding portion provided on the fixed portion 13.

The configuration such as the shape of the holding portion 20 in the wire fixing member 12 is not limited to the above embodiment. For example, the holding portion 20 may be an extending piece extending in the length direction of the wire member 11, and the wire member 11 may be fixed to the extending piece by winding tape or other means.

In the fixing member body 12a, the fixing portion 30 including the insertion hole 31 may be formed only in either the first part 41 or the second part 42.

The fixed portion 13 in the above embodiment has a flat plate shape, but there is no limitation to this. For example, the end portion of the fixed portion 13 in the width direction D3 may be bent at a substantially right angle, for example.

The insertion hole 31 of the wire fixing member 12 in the illustrated embodiment may be referred to as “a slot”, “a flat slot”, or “a polygonal slot”. For example, in the non-limiting embodiment shown in FIGS. 2, 3, and 5, the inner surface 31a of the insertion hole 31 can include a first flat receiving surface configured to be in direct contact with the first main surface 13x of the plate-like fixed portion 13 and a second flat receiving surface configured to be in direct contact with the second side surface 54 of the insertion member body 51. The second flat receiving surface may be spaced apart from the first flat receiving surface by a predetermined slot distance. As shown in FIG. 3, the thickness of the insertion member body 51 may be selected according to the aforementioned predetermined slot distance of the insertion hole 31 and the thickness of the plate-like fixed portion 13 so that the plate-like stack formed by overlapping the insertion member body 51 and the plate-like fixed portion 13 tightly fits in the insertion hole 31 with frictional resistance, for example. For example, in a case where one wire fixing member 12 is used together with different plate-like fixed portions 13 having a different thickness, the smaller the plate thickness of the plate-like fixed portion 13, the larger the thickness of the insertion member body 51 that can be selected for use.

Note that the embodiments and variations disclosed herein are to be considered as illustrative and non-limiting in all aspects. The scope of the present disclosure is indicated by the claims rather than the meaning described above, and is intended to include all changes within the meaning and scope equivalent to the claims.

1. A wire fixing member configured to fix a wire to a fixed portion, the wire fixing member comprising:
a fixing member body that is configured to hold the wire, the fixing member body including an insertion hole into which the fixed portion is to be inserted; and
an insertion body that is separate from the fixing member body and configured to be inserted into the insertion hole together with the fixed portion in order to press the fixed portion against an inner surface of the insertion hole.

2. The wire fixing member according to claim 1, wherein:
the fixing member body includes an elastic piece inside the insertion hole,
the elastic piece includes a lock configured to engage with the fixed portion so as to prevent the fixed portion from coming out of the insertion hole, and
the insertion body and the elastic piece are provided on opposite sides of the fixed portion in a thickness direction.

3. The wire fixing member according to claim 1,
wherein the insertion body includes an insertion member body and a reinforcement rib protruding from the insertion member body.

4. The wire fixing member according to claim 3, wherein:
the insertion member body includes a first side surface that is configured to come into contact with the fixed portion and a second side surface that is on a back side of the first side surface, and
the reinforcement rib is provided only on the second side surface and not the first side surface.

5. The wire fixing member according to claim 3,
wherein a plurality of the reinforcement ribs including the reinforcement rib are provided.

6. A wire harness comprising:
the wire fixing member according to claim 1, and
the wire that is held by the wire fixing member.
